(19) United States
(12) Patent Application Publication
(10) Pub. No.: US 2026/0290945 A1
(43) Pub. Date: Sep. 24, 2026

(54) BATTERY PACK AND VEHICLE

(71) Applicant: Scania CV AB, Södertälje (SE)

(72) Inventors: Alexei TSYCHKOV, Sollentuna (SE); Henrik HÖGBERG, Rönninge (SE)

(73) Assignee: Scania CV AB, Södertälje (SE)

(21) Appl. No.: 19/489,308

(22) PCT Filed: May 31, 2024
(86) PCT No.: PCT/SE2024/050544

§ 371 Date: Dec. 2, 2025

(30) Foreign Application Priority Data
Jun. 9, 2023 (SE) 2350704-9

(51) Int. Cl. H01M 10/658; B60L 50/64; H01M 10/625; H01M 10/647; H01M 10/6551; H01M 10/656; H01M 50/209; H01M 50/249

(52) U.S. Cl. CPC H01M 10/658; B60L 50/64; H01M 10/625; H01M 10/647; H01M 10/6551; H01M 10/656; H01M 50/209; H01M 50/249; H01M 2220/20

(57) ABSTRACT

The disclosure concerns a battery pack e.g., for a vehicle, the battery pack comprising at least one battery module, a casing configured to accommodate the at least one battery module, and one or more thermal insulation members. The battery module comprises a number of battery cells, and a heat transfer element. Each battery cell is connected to the heat transfer element and the one or more thermal insulation members are connected to the heat transfer element. The battery module is mounted in the casing via the one or more thermal insulation members.

### CROSS-REFERENCE TO RELATED APPLICATIONS

This application is a national stage application (filed under 35 U.S.C. § 371) of PCT/SE2024/050544, filed May 31, 2024, of the same title, which in turn claims priority to Swedish Patent App. No. 2350704-9, filed on Jun. 9, 2023; the contents of each of which are hereby incorporated herein by reference.

### TECHNICAL FIELD

The present disclosure relates to a battery pack and to a vehicle.

### BACKGROUND

Electric propulsion of vehicles provides many advantages, especially regarding local emissions. Electrically propelled vehicles comprise one or more electric propulsion motors configured to provide propulsive power to the vehicle. These types of vehicles can be divided into the categories: pure electric vehicles and hybrid electric vehicles.

Pure electric vehicles, sometimes referred to as battery electric vehicles, only-electric vehicles, and all-electric vehicles, comprise a purely electric powertrain and comprise no internal combustion engine and therefore produce no emissions in the area where they are driven.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating on purely electric propulsion when wanted, such as when driving in certain areas.

Aboard a vehicle, the electricity is usually stored in one or more battery packs, each comprising a number of rechargeable battery cells. Different types of battery cells may be used, such as lithium-ion cells, lithium polymer cells, and nickel-metal hydride cells. Also, other types of rechargeable cells may be used. A problem associated with battery packs is that most types, such as those including the cell types listed above, are temperature sensitive. This means that they have a temperature range in which they are most efficient. Moreover, too high temperatures and too low temperatures may damage and/or reduce cycle life of the battery pack. In addition, too high temperatures and too low temperatures may reduce the energy storing capacity of the battery cells of a battery pack which can have a negative impact on the available operational range of the vehicle.

A battery cell generates heat internally upon charging and discharging. Moreover, vehicles can operate in various ambient temperature conditions, which affects the temperature of the battery cells. Therefore, and for the above given reasons, the temperature of a battery pack of a vehicle is preferably regulated by a thermal management system. A thermal management system may be configured to cool battery cells under some operating conditions, such as during or after high current charge or discharge levels of the battery cells and/or during high ambient temperatures. Moreover, a thermal management system may be configured to heat battery cells under other operating conditions, such as when a vehicle is started and the temperature of the battery cells is below a threshold temperature, and the like. In some vehicles, and especially in pure electric vehicles, at least on some occasions such as when an electric system of the vehicle is not connected to a power grid, the thermal management system may utilize electric energy stored in the battery cells for operating the thermal management system. Thus, if so, the operation of the thermal management system may have a negative impact on the available operational range of the vehicle.

In addition, even though electric drive for vehicles can provide many advantages regarding energy efficiency of vehicles, the carbon footprint thereof, and the like, the efficient use of energy is also an important aspect for vehicles comprising an electric propulsion system.

### SUMMARY

It would be advantageous to achieve a battery pack overcoming, or at least alleviating, at least some drawbacks related to reduction of electric capacity and of cycle life of the battery cells of the battery pack. In particular, it would be desirable to provide a battery pack for efficient thermal management. To better address one or more of these concerns, one or more of a battery pack and a vehicle having the features defined in one or more of the independent claims is provided.

According to an aspect of the invention, there is provided a battery pack, the battery pack comprising at least one battery module, a casing configured to accommodate the at least one battery module, and one or more thermal insulation members. The at least one battery module comprises a number of battery cells and a heat transfer element. Each battery cell of the number of battery cells is connected to the heat transfer element and the one or more thermal insulation members are connected to the heat transfer element. The battery module is mounted in the casing via the one or more thermal insulation members.

Since the battery module comprising the number of battery cells is mounted in the casing via the one or more thermal insulation members, thermal bridges between the battery cells and the casing are prevented. Thus, ambient temperatures will affect the number of battery cells to a lesser degree than if thermal bridges where present. The energy which is needed for thermal management of the number of battery cells will therefore be reduced. Since this energy is obtained from the stored electric energy of the battery pack, the electric capacity of the battery pack will therefore be increased in comparison to battery packs having thermal bridges between their battery module and casing.

Further, thermal management of the number of battery cells can be performed in an efficient manner without their mounting in the casing affecting the temperature of the number of battery cells, at least not to any substantial degree.

Specifically, ambient cold temperatures will only cool the number of battery cells via the casing and ambient warm temperatures will only heat up the number of battery cells via the casing. Accordingly, the lack of thermal bridges ensures that temperature management of the number of battery cells, be it heating or cooling thereof, is mainly dependent on the temperature state of the battery cells themselves and ambient conditions, without being affected by thermal bridges and their higher thermal conductivity.

Moreover, thermal management of the battery cells can be performed in a predictable manner. Namely, since thermal bridges are prevented in the battery pack, thermal management of the number of battery cells utilizing the heat transfer element is predictable. No account has to be taken for ambient temperatures affecting the battery cells via thermal bridges. Only the temperature state of the battery cells themselves and ambient conditions have to be taken into account during thermal management, the thermal influence of thermal bridges does not need to be considered.

The overall degree of efficiency of a vehicle comprising one or more such battery packs thus, is improved and accordingly, the range of the vehicle is improved due to ambient temperatures affecting the battery cells to a lesser degree. Similarly, if utilized as a power source in other apparatuses than a vehicle, the overall degree of efficiency of the relevant apparatus comprising one or more such battery packs is improved.

Also, improved thermal management aspects of the battery pack will contribute to a long cycle life of the battery cells of the battery pack.

According to a further aspect there is provided an electrical power system comprising one or more electric motor(s) and one or more battery pack(s) according to any one of the aspects and/or embodiments discussed herein.

According to a further aspect there is provided a vehicle comprising an electric propulsion motor configured to provide propulsive power to the vehicle, wherein the vehicle further comprises one or more battery packs according to any one of aspects and/or embodiments discussed herein.

As discussed above, since the battery module comprising the number of battery cells is mounted in the casing via the one or more thermal insulation members, there are not provided any thermal bridges between the battery cells and the casing. Thus, efficient and predictable thermal management of the number of battery cells of the battery pack can be performed in the vehicle, which in turn increases the degree of efficiency of the vehicle and positively affects cycle life of the battery pack.

The vehicle is an electrically propelled vehicle and may be one of the above discussed types i.e., a pure electric vehicle or a hybrid electric vehicle. A further alternative may be that the vehicle is a fuel cell electrical vehicle or similar vehicle.

The battery pack is configured for storing electric energy. The vehicle may comprise one or more battery packs.

The present invention is not limited to any particular chemistry or structure of the battery cells used. The number of battery cells may comprise any type of battery cell that requires thermal management via a heat transfer element, such as one of lithium-ion cells, lithium polymer cells, and nickel-metal hydride cells and the structure of the cells may be e.g., of prismatic type, of cylindrical type, or of pouch type.

The battery cells of the number of battery cells are temperature sensitive and are preferably operated within a specified temperature range, such as e.g., 20-40 degrees Celsius for lithium-ion cells. Other types of cells may have other specified temperature ranges. Operation outside a specified range is possible but may have negative effects.

The heat transfer element may form part of, or may be connected to, a thermal management system. The thermal management system is configured to regulate the temperature of the number of battery cells of the battery pack e.g., to within a defined temperature range, such as the above-mentioned temperature range.

The term thermal management thus, relates to a regulation of the temperature of the number of battery cells. Thermal management may be performed by a thermal management system.

The thermal management system may be configured to cool the number of battery cells under some operating conditions, such as during or after high level current charge or discharge and/or at high ambient temperatures. Moreover, a thermal management system may be configured to heat the number of battery cells under other operating conditions, such as when ambient temperatures are low.

A thermal bridge is an area or portion of an object that has higher thermal conductivity than the surrounding areas or portions. Such thermal bridges create a path of least resistance for heat transfer. Accordingly, thermal bridges affect thermal insulation of an object in a negative manner.

The casing may be any suitable casing for protectively enclosing the number of battery cells. The casing may be made from one or more of a polymer material, a metal material, fibrous components, etc. The casing may be made from a composite material.

The casing may be thermally insulated. The casing may be substantially airtight. Thus, a gas, such as air within the casing may form a thermal insulation around the battery module.

As mentioned above, each battery cell of the number of battery cells is connected to the heat transfer element. Thus, each battery cell of the number of battery cells is in heat transferring contact with the heat transfer element. Accordingly, cooling the heat transfer element e.g., with a heat transfer fluid, will cool the number of battery cells and heating the heat transfer element e.g., with a heat transfer fluid, will heat the number of battery cells.

In the battery pack, the one or more thermal insulation members may form one or more intermediate members between the heat transfer element and the casing.

The thermal insulation members have thermal insulation properties and thus, do not form thermal bridges between the heat transfer element and the casing.

The battery pack may comprise at least part of a cell control system or a cell control system may be separate from the battery pack. Briefly, a cell control system is configured to measure voltages and temperatures and to control operation of the battery pack.

According to embodiments, the heat transfer element may extend along a two-dimensional plane. In this manner, the heat transfer element may have an essentially flat extension.

Thus, the number of battery cells may be arranged next to each other on one or both sides of the heat transfer element.

According to embodiments, the one or more thermal insulation members may be arranged laterally of the heat transfer element. In this manner, one or both main surfaces of the heat transfer element may be free to be utilized for connecting the number of battery cells thereto.

Put differently, the one or more thermal insulation members may be arranged at a periphery of the heat transfer element.

More specifically, the heat transfer element may be generally flat and have an extension in both dimensions of the two-dimensional plane. Thus, a main surface of the heat transfer element may extend substantially perpendicularly to a normal line of the two-dimensional plane. Accordingly, an arrangement laterally of the heat transfer element, such as the one or more thermal insulation members, is arranged at an edge of the heat transfer element.

According to embodiments, the casing may comprise at least one recess for receiving at least a portion of the one or more thermal insulation members. In this manner, the heat transfer element and accordingly, the battery module, may be mounted in the casing via the one or more thermal insulation members.

According to embodiments, the casing may comprise at least a first and a second casing portion, and the at least one recess may be formed between the first and second casing portions. In this manner, the casing may be provided with the at least one recess for mounting the battery module in a convenient way.

Also, the casing comprising at least a first and a second casing portion may provide for a convenient assembly of the battery pack since the one or more thermal insulation members arranged laterally of the heat transfer element may be positioned against one of the first and second casing portions at the recess and thereafter, the other of the first and second casing portions may be positioned against the one or more thermal insulation members.

According to embodiments, the battery module may be supported in the casing via the one or more thermal insulation members only. In this manner, an entire weight of the battery module may be suspended only by the one or more thermal insulation members in the casing.

Thus, there may not be formed any other supporting contact between the battery module and the casing. This may prevent thermal bridges between the battery module and the casing.

According to embodiments, the heat transfer element may be self-supporting. In this manner, the components of the battery module may be carried by the heat transfer element and be suspended in the casing without separate elements supporting the heat transfer element.

Further features of, and advantages with, the invention will become apparent when studying the appended claims and the following detailed description.

### BRIEF DESCRIPTION OF THE DRAWINGS

Various aspects and/or embodiments, including particular features and advantages, will be readily understood from the example embodiments discussed in the following detailed description and the accompanying drawings, in which:

FIG. 1 schematically illustrates a vehicle according to embodiments,

FIGS. 2a-2d illustrate a battery pack according to embodiments,

FIGS. 3a and 3b illustrate a battery module according to embodiments, and

FIGS. 4a and 4b illustrate portions of a battery pack and of a battery module.

### DETAILED DESCRIPTION

Aspects and/or embodiments will now be described more fully. Like numbers refer to like elements throughout. Well-known functions or constructions will not necessarily be described in detail for brevity and/or clarity.

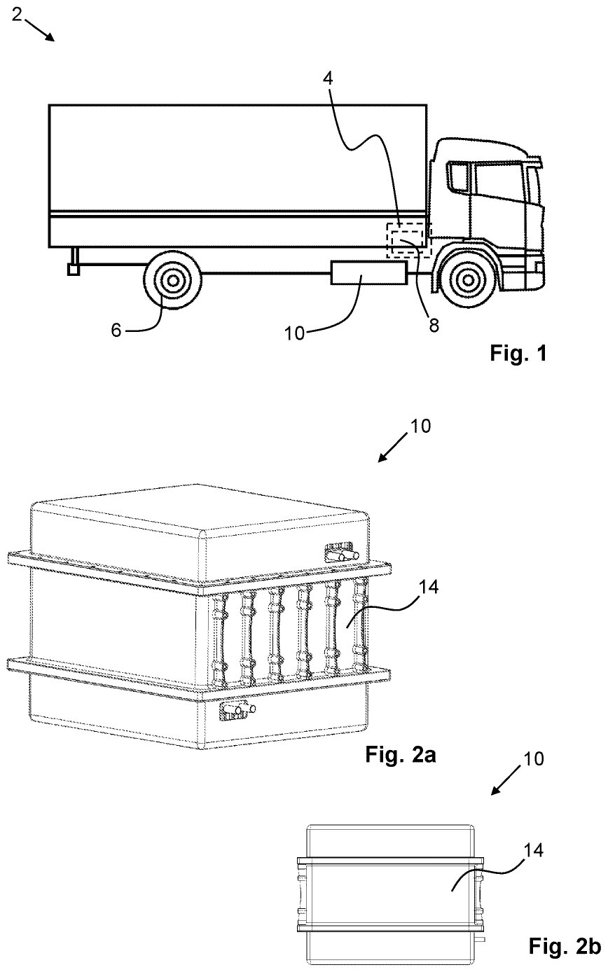

FIG. 1 schematically illustrates a vehicle 2 according to embodiments.

The vehicle 2 is a vehicle 2 according to any one of aspects and/or embodiments discussed herein.

According to the illustrated embodiments, the vehicle 2 is a truck, i.e. a type of heavy vehicle. According to further embodiments, the vehicle 2, as referred to herein, may be another type of heavy or lighter type of manned or unmanned vehicle for land or water based propulsion such as a lorry, a bus, a construction vehicle, a tractor, a car, a ship, a boat, or the like.

The vehicle 2 comprises an electric powertrain 4. According to the illustrated embodiments, the electric powertrain 4 is configured to provide propulsive power to the vehicle 2 via wheels 6 of the vehicle 2. The electric powertrain 4 comprises an electric propulsion motor 8. The electric propulsion motor 8 is configured to provide propulsive power to the vehicle 2 via other parts of the powertrain 4 and the wheels 6 of the vehicle 2 as well as providing regenerative braking of the vehicle 2. Thus, according to the illustrated embodiments, the electric propulsion motor 8 is capable of operating as an electric motor as well as an electric generator. The electric propulsion motor 8 of the vehicle 2 may also be referred to as a vehicle propulsion motor/generator.

According to the illustrated embodiments, the electric powertrain 4 of the vehicle 2 is a pure electric powertrain 4, i.e. a powertrain comprising no internal combustion engine. According to alternative embodiments, the electric powertrain of the vehicle 2 may be a so-called hybrid electric powertrain comprising a combustion engine in addition to the electric propulsion motor for providing propulsive power to the vehicle.

Moreover, in FIG. 1, a battery pack 10 of the vehicle 2 is indicated.

The vehicle 2 comprises one or more battery packs 10 according to any one of the aspects and/or embodiments discussed herein. The one or more battery packs 10 are operably connected to the electric propulsion motor 8 and are configured to provide electric current thereto and/or to receive electric current therefrom. As is further explained herein, the battery pack 10 comprises a number of battery cells arranged in at least one battery module of the battery pack 10.

However, the herein discussed battery pack 10 may be suited for supplying electric power to other kinds of apparatuses than an electric vehicle, such as in stationary applications. The battery pack 10 may supply electric power to electric motors in other kinds of apparatuses and/or the battery pack 10 may supply electric power to other kind of electric consumers than electric motors. Furthermore, the battery pack 10 discussed herein may form part of an electrical power system comprising one or more battery packs 10 and one or more electric motors. The one or more battery packs 10 are then connected to the one or more electric motors.

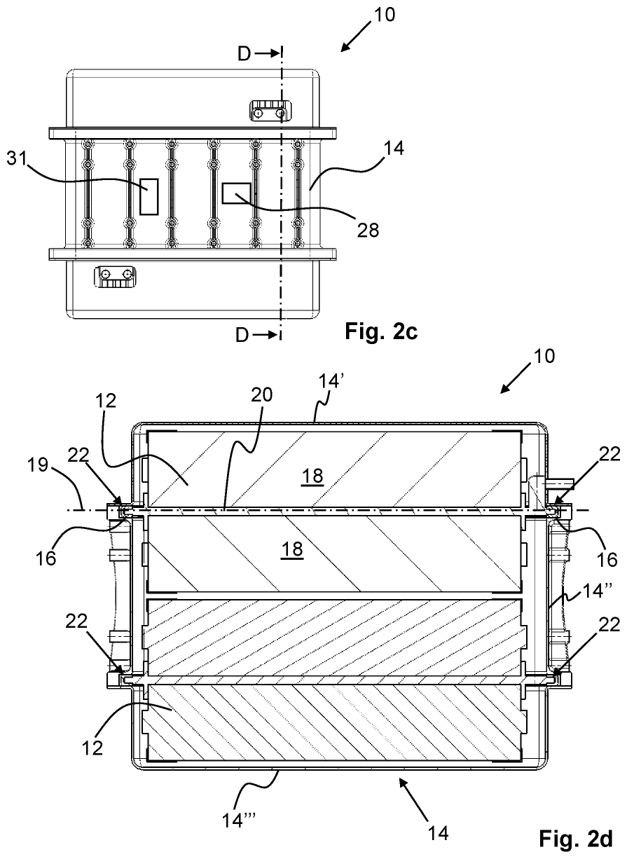

FIGS. 2a-2d illustrate a battery pack 10 according to embodiments. FIG. 2a shows an isometric view of the battery pack 10. FIGS. 2b and 2c show side views of the battery pack 10. FIG. 2d shows a cross section along line D-D in FIG. 2c through the battery pack 10.

The battery pack 10 may be a battery pack 10 for a vehicle, such as one of the vehicles discussed above with reference to FIG. 1.

Accordingly, the battery pack 10 may be configured to provide electricity to an electric propulsion motor of the vehicle.

The battery pack 10 comprises at least one battery module 12, a casing 14 configured to accommodate the at least one battery module 12, and one or more thermal insulation members 16.

In the illustrated embodiments, the battery pack 10 comprises two battery modules 12. According to alternative embodiments, the battery pack may comprise only one battery module 12 or more than two battery modules 12.

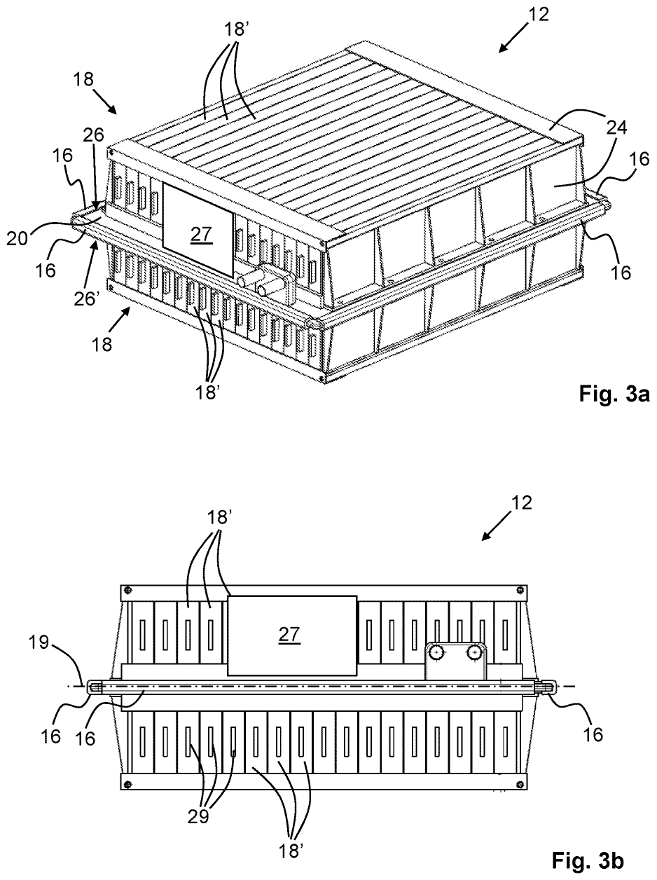

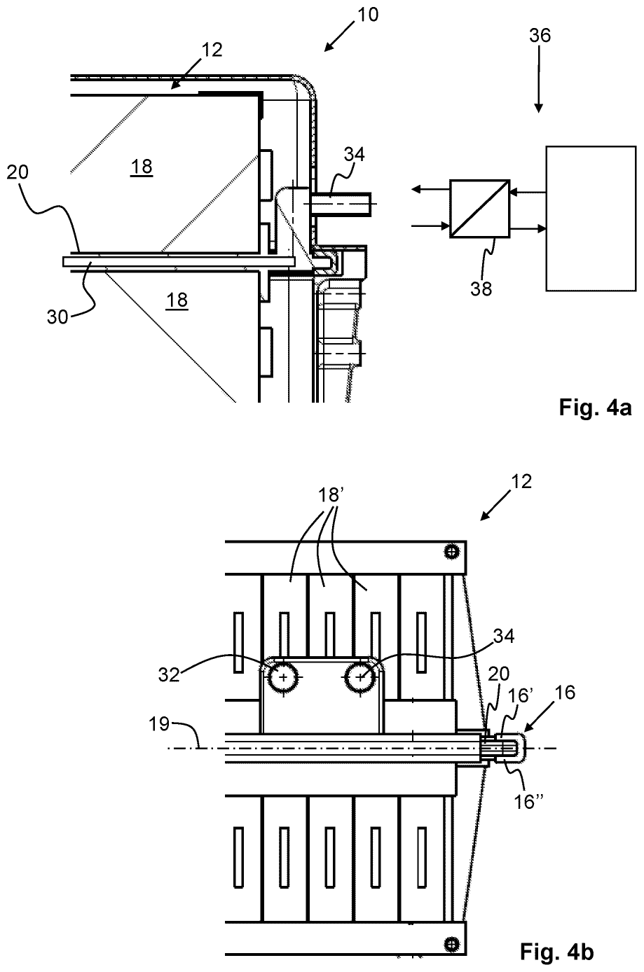

The battery module 12 comprises a number of battery cells 18 and a heat transfer element 20. Each battery cell of the number of battery cells 18 is connected to the heat transfer element 20, see further below with reference to FIGS. 3a-4b.

The one or more thermal insulation members 16 are connected to the heat transfer element 20. The battery module 12 is mounted in the casing 14 via the one or more thermal insulation members 16. Thus, thermal bridges between the battery module 12 and the casing 14 are avoided.

A gas, such as air, may fill the casing 14. Thus, the at least one battery module 12 is surrounded by gas and thermally insulated from the casing 14 by the gas within the casing 14.

A further alternative may be that a thermally insulating material, such as a foam sheet or a moulded extruded polystyrene foam shell, is arranged between the at last one battery module 12 and the casing 14.

Accordingly, as a whole, the at least one battery module 12 is thermally insulated from the casing 14 by the one or more thermal insulation members 16 and the gas and/or other thermally insulating material surrounding the at least one battery module 12. The above discussed advantages of electric capacity and predictable and efficient thermal management of the number of battery cells are thus, achievable in the battery pack 10.

More specifically, due to the thermal insulation members 16, a thermal management system may operate in a more efficient manner with a reduced leakage of heat between the number of battery cells 18 and the casing 14 of the battery pack 10. Moreover, due to the thermal insulation member 16, conditions are provided for regulating the temperature of the number of battery cells 18 to more ideal temperature ranges in an energy efficient manner. Thereby, conditions are also provided for prolonging an available operational range of a vehicle comprising the battery pack 10 and increasing a total energy efficiency of the vehicle or of a different kind of apparatus comprising the battery pack 10. In addition, because conditions are provided for regulating the temperature of the number of battery cells 18 to more ideal temperature ranges, the cycle life of the number of battery cells 18 can be increased.

The heat transfer element 20 extends along a two-dimensional plane 19. Thus, the heat transfer element 20 has an essentially planar shape. The two-dimensional plane 19 may be an imaginary plane and is in FIG. 2d indicated for one of the battery modules 12 with a dash-dotted line. The two-dimensional plane 19 extends perpendicularly to the plane of FIG. 2d.

The one or more thermal insulation members 16 are arranged laterally of the heat transfer element 20. That is, the one or more thermal insulation members 16 may be arranged at a periphery of the heat transfer element 20, at an edge of the heat transfer element 20, or at a circumference of the heat transfer element 20.

The one or more thermal insulation members 16 may be arranged in direct abutment with the heat transfer element 20 or there may be arranged one or more intermediate members between the one or more thermal insulation members 16 and the heat transfer element 20. Still, in both cases, the one or more thermal insulation members 16 may be arranged laterally of the heat transfer element 20.

The casing 14 comprises at least one recess 22 for receiving at least a portion of the one or more thermal insulation members 16. The battery module 12 is thus, via the heat transfer element 20 and the one or more thermal insulation members 16 mounted in the casing 14.

For instance, the one or more thermal insulation members 16 may have an elongated extension and the at least one recess 22 may be formed by one or more elongated slots in the casing 14, the one or more elongated slots having a depth and a length suited for receiving the one or more thermal insulation members 16. Thus, the thermal insulation member 16 may fit into the recess 22.

The one or more thermal insulation members 16 may fit with an interference fit in the recess 22.

In the illustrated embodiments, the casing 14 comprise at least a first and a second casing portion 14′, 14″. The at least one recess 22 is formed between the first and second casing portions 14′, 14″.

The at least one or more thermal insulation member 16 may be clamped between the first and second casing portions 14′, 14″.

For instance, for a battery pack comprising only one battery module 12, the casing could comprise only two casing halves i.e., a first casing portion and a second casing portion. The recess 22 would be formed between the two casing halves and battery module 12 would be fitted in the recess between the two halves.

In the illustrated embodiments, the battery pack 10 comprises two battery modules 12 and the casing 14 comprises an additional third casing portion 14″′. Recesses 22 are formed between each pair of casing portions i.e., between the first and second casing portions 14′, 14″ and between the second and third casing portions 14″, 14″′. Each of the battery modules 12 is mounted in the recesses 22 formed between each pair of casing portions 14′, 14″, 14″′.

In the illustrated embodiments, the at least one battery module 12 is supported in the casing 14 via the one or more thermal insulation members 16. In this manner, the at least one battery module 12 may be supported in the casing 14. The one or more thermal insulation members 16 being connected to the heat transfer element 20 thus, may at least contribute to the mounting of the battery module 12 in the casing 14.

Moreover, in the illustrated embodiments, the battery module 12 is supported in the casing 14 via the one or more thermal insulation members 16, only. Thus, the entire weight of each battery module 12 is suspended by its respective one or more thermal insulation members 16 in the casing 14.

Put differently, in the illustrated embodiments, no other supporting means may be required for suspending the battery module 12 in the casing 14.

Electrical connectors 28, 31 may be provided on the casing 14. A high current/voltage connector 28 connects the battery cells 18′ to the electric motor/generator and/or to a battery charger. A control circuit connector 31 connects the battery cells 18′ to control equipment.

See below with reference to FIGS. 3a-4b for a discussion of further features of the battery pack 10 and the battery module 12.

FIGS. 3a and 3b illustrate a battery module 12 according to embodiments. FIG. 3a shows an isometric view and FIG. 3b shows a side view of the battery module 12.

The battery module 12 of these embodiments resembles in much the battery module 12 of the battery pack 10 discussed in connection with FIGS. 2a-2d. Accordingly, reference is also made to the above discussion of the battery pack 10 of FIGS. 2a-2d.

Again, the battery module 12 is to be accommodated in a casing 14 of a battery pack 10. Again, the battery module 12 comprises a number of battery cells 18 and a heat transfer element 20.

Each battery cell 18′ of the number of battery cells 18 is connected to the heat transfer element 20. For instance, the battery cells 18′ may be screwed, glued and/or pressed against the heat transfer element 20 by cell fixation members 24.

In the illustrated embodiments, the number of battery cells 18 and accordingly, the battery module 12, comprises 34 battery cells 18′. In the illustrated embodiments 17 battery cells 18′ are arranged on each side of the heat transfer element 20.

According to embodiments, such as the illustrated embodiments, each battery cell 18′ of the number of battery cells 18 is arranged in heat transferring abutment with the heat transfer element 20. In this manner, thermal management of each battery cell 18′ may be efficiently performed via the heat transfer element 20.

In the illustrated embodiments, the battery cells 18′ of the number of battery cells 18 are arranged in heat transferring abutment on both sides 26, 26′ of the heat transfer element 20. For instance, one half of the number of battery cells 18 is connected to a first side 26 of the heat transfer element 20 and the other half of the number of battery cells 18 is connected to a second side 26′ of the heat transfer element 20.

In alternative embodiments, the battery cells 18′ may be arranged on only one side of the heat transfer element 20.

As discussed above, the heat transfer element 20 has a substantially planar shape by extending along a two-dimensional plane 19. Thus, the heat transfer element 20 has two main sides or surfaces 26, 26′ facing in opposite directions of the heat transfer element 20 and of the two-dimensional plane 19.

Again, one or more thermal insulation members 16 are provided and connected to the heat transfer element 20 for mounting of the battery module 12 in the casing 14.

In the illustrated embodiments, there are provided four thermal insulation members 16.

Alternatively, there may be provided less or more than four thermal insulation members 16. For instance, a shape of the heat transfer element may determine the number of thermal insulation members. One thermal insulation member may be provided for each edge of the heat transfer element. A further alternative may be to provide more than one thermal insulation member for each edge of the heat transfer element.

The heat transfer element 20 may be self-supporting. That is, the heat transfer element 20 may be configured for supporting its own weight as well as the weight of the number of battery cells 18 and any other components carried by the heat transfer element 20. Thus, the heat transfer element 20 as such may be configured for suspending the battery module 12 in the casing 14.

For instance, the heat transfer element 20 may comprise two sheet metal side elements forming main portions of the first and second surfaces 26, 26′. A frame structure may be provided in the heat transfer element 20.

The thermal insulation members 16 have thermal insulation properties and thus, eliminate thermal bridges between the battery module 12 and the casing 14.

According to some embodiments, the one or more thermal insulation members 16 may be made from a polymeric material. In this manner, the thermal insulation properties may be provided by a material that provides easy manufacturing properties. For instance, thermal insulation members 16 may be produced in an injection moulding process or in an extrusion process.

Mentioned purely as examples, the polymeric material may be one or more of a natural or synthetic rubber, such as EPDM-rubber, silicon based polymeric material, or composite plastic materials.

Alternatively, the one or more thermal insulation members 16 may be made from different materials having thermal insulation properties than polymeric materials, such as e.g. ceramic materials.

According to some embodiments, the one or more thermal insulation members 16 may have elastic properties. Thus, the battery module 12 may be mounted in the casing 14 via the one or more thermal insulation members 16 in a manner that provides shock absorbing properties. This may be advantageous to ensure protection of the battery module 12 and the number of battery cells 18.

Elastic properties may be provided by many rubber and polymeric materials.

According to some embodiments, the one or more thermal insulation members 16 may be electrically insulating. In this manner, the casing 14 may be prevented from being electrically charged or electrically conducting in case the battery module 12 and/or battery cells 18′ should malfunction.

Electrically insulating properties may be provided by many rubber and polymeric materials.

According to some embodiments, the at least one battery module 12 may further comprise one or more of cell fixation members 24 arranged for connecting the battery cells 18′ to the heat transfer element 20, a cell control system 27, and/or electrical connectors 28 for electrically connecting the number of battery cells 18 to an electric propulsion motor and/or an electric power source.

Thus, one or more of the following may be provided:
A secure connection of the number of battery cells 18 to the heat transfer element 20. For instance, as illustrated, the cell fixation members 24 may comprise strips and ribs forming a cage-like structure around battery cells 18′. The cage-like structure is connected to the heat transfer element 20. The cage-like structure may also contribute to maintaining a suitable compressive force around the battery cells 18′.
A control of the battery cells 18′, at least partially via the cell control system 27. The cell control system 27 may comprise a known so-called Cell Monitoring Circuit, CMC. The CMC measures voltages and temperatures within the battery pack. Voltages and temperatures, in turn, are communicated to a known Battery Management System, BMS (not shown).
And via the electrical connectors 28, see FIG. 2c, electrical connection to an electric power consumer in the form of the electric motor/generator, to an electric power source in the form of the electric motor/generator, and/or to an external electric power source, such as a battery charger. Accordingly, the electrical connectors 28 are high voltage/current connectors for conducting electric current to/from the battery cells 18, 18′.

Further, there are provided low voltage connections 29 for control and monitoring of the battery cells 18, 18′ and for communicating with parts of the cell control system 27, such as the CMC and/or the BMS.

In a known manner, the BMS and/or one or more of an on/off switch system, a battery fuse, an electric current sensor, an electric voltage sensor may be provided in a so-called Battery Junction Box (not shown). The Battery Junction Box may be arranged withing the casing 14 or outside the casing 14.

In a known manner, the battery pack 10 may comprises pressure equalization and gas evacuation systems.

See below with reference to FIGS. 4a and 4b for a discussion of further features of the battery pack 10 and the battery module 12.

FIGS. 4a and 4b illustrate a cross-sectional portion of the battery pack 10 of FIG. 2a- 2d and a portion of the battery module 12 of FIGS. 3a and 3b.

According to some embodiments, such as the illustrated embodiments, one or more portions 16′, 16″ of the one or more thermal insulation members 16 may extend along and/or in parallel with the two-dimensional plane 19.

In the illustrated embodiments, the one or more thermal insulation members 16 have a U-shaped cross section that extends around edge portions of the heat transfer element 20. The two leg portions 16′, 16″ of the U-shaped cross section extend in parallel with the two-dimensional plane 19.

According to embodiments, within the heat transfer element 20, one or more channels 30 for a heat transfer fluid are formed, wherein the battery pack 10 comprises an inlet conduit 32 for the heat transfer fluid and an outlet conduit 34 for the heat transfer fluid, the inlet and outlet conduits 32, 34 being arranged in fluid communication with the one or more channels 30. In this manner, the heat transfer element 20 may be configured for thermal management of the number of battery cells 18.

Namely, via the inlet conduit 32 heat transfer fluid may be conducted to the one or more channels 30 in the heat transfer element 20. As the heat transfer fluid is conducted through the one or more channels 30, the temperature of the number of battery cells 18 is affected by the temperature of the heat transfer fluid. That is, depending on operational circumstances, the number of battery cells 18 are heated or cooled by the heat transfer fluid. The heat transfer fluid is conducted from the one or more channels 30 of the heat transfer element 20 via the outlet conduit 34.

A thermal management system 36 may be connected to the heat transfer element 20 or the heat transfer element 20 may form part of the thermal management system 36. The thermal management system 36 is configured for supplying heated or cooled heat transfer fluid to the heat transfer element 20 of the battery module 12 and the battery pack 10. For instance, the thermal management system 36 may comprise a heat pump, which via a heat exchanger 38 heats or cools the heat transfer fluid. That is, depending on whether the evaporator or the condenser of the heat pump is connected to the heat exchanger 38.

Accordingly, the heat transfer element 20 may form part of a unit for regulating a temperature of the battery cells 18′. That is, the unit for regulating a temperature of the battery cells may be, or may form part of, a thermal management system 36.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A battery pack comprising:
at least one battery module;
a casing configured to accommodate the at least one battery module and one or more thermal insulation members,
wherein the at least one battery module comprises a number of battery cells, and a heat transfer element,
wherein each battery cell of the number of battery cells is connected to the heat transfer element and the one or more thermal insulation members are connected to the heat transfer element, and
wherein the battery module is mounted in the casing via the one or more thermal insulation members

2. The battery pack according to claim 1, wherein the heat transfer element extends along a two-dimensional plane.

3. The battery pack according to claim 2, wherein the one or more thermal insulation members are arranged laterally of the heat transfer element.

4. The battery pack according to claim 2, wherein one or more portions of the one or more thermal insulation members extend along and/or in parallel with the two-dimensional plane.

5. The battery pack according to claim 1, wherein the casing comprises at least one recess for receiving at least a portion of the one or more thermal insulation members.

6. The battery pack according to claim 5, wherein the casing comprises at least a first and a second casing portion, and wherein the at least one recess is formed between the first and second casing portions.

7. The battery pack according to claim 1, wherein the at least one battery module is supported in the casing via the one or more thermal insulation members.

8. The battery pack according to claim 1, wherein each battery cell of the number of battery cells is arranged in heat transferring abutment with the heat transfer element.

9. The battery pack according to claim 1, wherein the heat transfer element is self-supporting.

10. The battery pack according to claim 1, wherein within the heat transfer element one or more channels for a heat transfer fluid are formed, and wherein the battery pack comprises an inlet conduit for the heat transfer fluid and an outlet conduit for the heat transfer fluid, the inlet and outlet conduits being arranged in fluid communication with the one or more channels.

11. The battery pack according to claim 1, wherein the heat transfer element forms part of a unit for regulating a temperature of the battery cells.

12. The battery pack according to claim 1, wherein the at least one battery module further comprises one or more of cell fixation members arranged for connecting the battery cells to the heat transfer element, a cell control system, and/or electrical connectors for electrically connecting the battery cells to an electric motor and/or an electric power source.

13. The battery pack according to claim 1, wherein the battery pack is configured to provide electricity to an electric propulsion motor of a vehicle.

14. An electrical power system comprising:
one or more electric motors; and
one or more battery packs comprising:
at least one battery module;
a casing configured to accommodate the at least one battery module; and
one or more thermal insulation members,
wherein the at least one battery module comprises a number of battery cells, and a heat transfer element,
wherein each battery cell of the number of battery cells is connected to the heat transfer element and the one or more thermal insulation members are connected to the heat transfer element, and
wherein the battery module is mounted in the casing via the one or more thermal insulation members.

15. A vehicle comprising:
an electric propulsion motor configured to provide propulsive power to the vehicle; and
one or more battery packs comprising:
at least one battery module;
a casing configured to accommodate the at least one battery module; and
one or more thermal insulation members,
wherein the at least one battery module comprises a number of battery cells, and a heat transfer element,
wherein each battery cell of the number of battery cells is connected to the heat transfer element and the one or more thermal insulation members are connected to the heat transfer element, and
wherein the battery module is mounted in the casing via the one or more thermal insulation members.
